(19) United States
(12) Patent Application Publication
(10) Pub. No.: US 2008/0077652 A1
(43) Pub. Date: Mar. 27, 2008

(54) Method and system for providing an enhanced service-oriented architecture

(75) Inventors: Hugh Grant, New York, NY (US); Chris Swan, Haywards Heath (GB)

Correspondence Address: KING & SPALDING;CREDIT SUISSE SECURITIES (USA) LLC, 1180 PEACHTREE STREET, NE, 34TH FLOOR, ATLANTA, GA, 30309-3521, US

(73) Assignee: Credit Suisse Securities (USA) LLC One Madison Avenue, New York, NY (US)

(21) Appl. No.: 11/516,173

(22) Filed: Sep. 6, 2006

(51) Int. Cl. G06F 15/16

(52) U.S. Cl. 709/203

(57) ABSTRACT

Using an enhanced service contract to support the design, deployment, testing, and operation of an enterprise-wide service-oriented architecture. The enhanced service contract includes both static and dynamic parameters and may be contained in an electronic format to facilitate automating of certain design, deployment, testing, and operation functions. The enhanced service contract supports validating system requirements for a service, including developing test code used to test services. The enhanced service contract also supports performance testing during operations and supports allocating system costs and optimizing system resources.

### FIELD OF THE INVENTION

This invention relates to a system and method for providing an enhanced service-oriented computer architecture. More particularly, this invention relates to developing enhanced services contracts and using enhanced services contracts to support design, deployment, and operation of service oriented computer networks.

### BACKGROUND OF THE INVENTION

Service level agreements are at the core of most enterprise information technology (IT) systems. Service level agreements are contracts between service providers and customers that define the services provided, the metrics associated with these services, acceptable and unacceptable service levels, liabilities on the part of the service provider and the customer, and actions to be taken in specific circumstances. The “service provider” may be a company's internal IT group or a third-party computer network services provider. Similarly, the “customer” may be a company or a group within a company.

From the earliest days of enterprise computing, service levels have been used as a key indicator of performance in meeting the goals of a given computing application, service, or component. These service levels have typically involved such measures as transactions per second, percentage uptime, latency, number of concurrent users, and the like and have been managed through the active monitoring of the computing systems involved. Service Level Agreements (SLAs) establish a “contract” between the service producer and the service consumer. Based on their experience, system designers map these SLAs onto technical platforms, making hardware and software decisions based on their best effort and estimating the real-world service levels that can be supported by a particular system. In reality, these estimates must be constantly validated by the real-time active monitoring of the system under real-world conditions. Choosing these monitoring points and interpreting the results is an important aspect of the operational management of a large enterprise system. Typically, these SLAs apply to a traditional two-tier (client-server) and three-tier (client-application server-database) architecture.

Treating computing as a service has become more commonplace of late, and there has been growing adoption of service-oriented approaches to building systems, such as the Service-Oriented Architecture (or SOA). SOA treats services as the most fundamental component of a system's architecture and design, and one of the goals of SOA is to promote service reuse and customization, envisaging a situation where a set of 2- or 3-tier distributed applications today would be replaced with possibly dozens of interdependent services.

These SOA services are loosely coupled through invokable interfaces. These interfaces are themselves independent of the services. Applications are composed out of multiple services. As a result, each software application is a web of operating components, as opposed to a single end-to-end chain. Because multiple platforms may be employed, different components within the same software application may have their own monitoring, configuration, and management framework. This web-like linking of services enables an overall system to rely on services operating on platforms running different operating systems. World-wide-web-based services are typically structured in this architecture and web-based languages and protocols are often used. However, SOA is broader than the World Wide Web and independent of a specific technology or language.

The approach to managing SLAs for these new SOA systems has not changed, however, and is still following the approach used in pre-SOA distributed computing: active monitoring of services after they have been deployed. However, SOA greatly increases the complexity of the computing landscape. Instead of maybe two, three, or four tiers of distributed systems, a complex SOA will typically have dozens of services, some dependent on others, all linked together through some sort of workflow or process management layer. Services are likely to be implemented in several different languages, on several different hardware and software platforms. The “traditional” approach to dealing with service levels—essentially, treating them as an afterthought to be managed by active monitoring after the system has been constructed—is no longer appropriate. With an SOA, this traditional approach leads to enormous complexity, as the SLA of a single component will depend on the context within which it is invoked, and what may be acceptable for one user, may be an unacceptable breach of the SLA for another.

However, this complexity may be addressed by changing the usual relationship between the service level agreement and the software component. What is needed is an SLA-oriented approach that integrates with the interface-driven approach found in SOA today to build a more “contract-oriented” architecture. By tightly integrating interface descriptions and service level requirements into a single “contract,” system designers can better manage the complexity inherent in SOA and build more predictable systems.

In view of the foregoing, there is a need to provide a system and method that can implement and use a service contract having both static and dynamic network parameters for an enterprise system based on service-oriented architecture. The present invention provides a system and method for an enhanced service-oriented computer architecture that develops and uses enhanced service contracts, that is, service contracts that include both static and dynamic parameters, to design, deploy, and operate an enterprise computer network.

### SUMMARY OF THE INVENTION

The present invention provides a system and method for an enhanced service-oriented computer architecture that develops and uses enhanced service contracts, that is, service contracts that include both static and dynamic parameters, to design, deploy, and operate an enterprise computer network. The present invention overcomes the complexity of employing service levels in an SOA by changing the usual relationship between the service level agreement and the software component. The present invention integrates the service level requirements into the system architecture and design. The present invention automatically generates networking adapters, test code, monitoring code, and the like, and can analyze an existing system to verify that the system can meet desired service level requirements as the system has been designed, as well as whether the system can meet the service level requirements in practice.

In one aspect of the invention, a system for providing a service-oriented architecture is provided. The system includes an enterprise information technology system that includes multiple services and an enhanced services contract associated with each of these services. The enhanced services contract includes a requirement related to a static parameter of one of the services and a requirement comprising a dynamic parameter of that service.

In another aspect of the present invention, a method for generating an enhanced services contract is provided. This method includes the steps of (1) identifying a service level requirement for a service of a service-oriented enterprise information technology system; (2) identifying a static interface parameter for the service; and (3) generating a computer readable document comprising the service level requirement and the static interface parameter.

In yet another aspect of the present invention, a method for evaluating a composite service for a service oriented enterprise information technology system is provided. The method includes the steps of (1) identifying for the composite service an enhanced services contract, which includes a first set of requirements; (2) identifying for each constituent service accessed by the composite service an enhanced services contract, which includes a second set of requirements; and (3) evaluating whether the second set of requirements satisfy the first set of requirements to determine whether the constituent services can satisfy the first set of requirements.

In yet another aspect of the present invention, a method for testing a composite service of a service oriented enterprise information technology system is provided. The method includes the steps of (1) identifying the composite service and one or more constituent services accessed by the composite service, where the composite service and the one or more support services each include an enhanced services contract; (2) identifying a set of requirements from the enhanced services contracts for the composite service and the constituent services; and (3) generating a test code based on the set of requirements, where the test code tests one or more capabilities of the composite service and the constituent services.

In yet another aspect of the present invention, a method for evaluating a client/service flow of a service oriented enterprise information technology system is provided. The method includes the steps of (1) identifying all service oriented enterprise information technology system resources comprising the client/service flow; (2) associating an enhanced services contract with each identified resource; (3) automatically developing an enhanced services contract specific to the client/service flow based on each enhanced services contract associated with each identified resource, where the enhanced services contract specific to the client/service flow includes a set of requirements; and (4) evaluating the set of requirements to determine the acceptability of the requirements for the client/service flow.

In yet another aspect of the present invention, a method for evaluating the performance of a client/service flow of a service oriented enterprise information technology system is provided. The method includes the steps of (1) retrieving an enhanced services contract associated with the client/service flow of a service oriented enterprise information technology system; (2) establishing monitoring criteria based on the enhanced services contract; and (3) comparing the performance of the system to the established monitoring requirements.

In yet another aspect of the present invention, a method for evaluating the performance of a client/service flow of a service oriented enterprise information technology system is provided. The method includes the steps of (1) retrieving an enhanced services contract that includes one or more service levels associated with the client/service flow of a service oriented enterprise information technology system; (2) retrieving a monitoring report for the client/service flow of a service oriented enterprise information technology system services; (3) determining the services used by the client/service flow of a service oriented enterprise information technology system; and (4) determining if any service levels for the client/service flow of a service oriented enterprise information technology system were breached.

Other aspects of the invention include a computer-readable storage device storing a set of computer-executable instructions implementing one or more of the methods of the present invention.

The aspects of the present invention may be more clearly understood and appreciated from a review of the following detailed description of the disclosed embodiments and by reference to the drawings and claims.

### BRIEF DESCRIPTION OF THE DRAWINGS

FIG. 1 depicts an operating environment in accordance with an exemplary embodiment of the present invention.

FIG. 2 depicts a segment of an operating environment and illustrates enhanced service contracts in accordance with an exemplary embodiment of the present invention.

FIG. 3a depicts the composition of an enhanced services contract for an exemplary embodiment of the present invention.

FIG. 3b depicts the composition of an enhanced services contract for an exemplary embodiment of the present invention.

FIG. 3c depicts the composition of an enhanced services contract for an alternative exemplary embodiment of the present invention.

FIG. 4 presents an overall process flow diagram for developing an enhanced service contract in accordance with an exemplary embodiment of the present invention.

FIG. 5 presents a process flow diagram for validating an enhanced service contract in accordance with an exemplary embodiment of the present invention.

FIG. 6 presents a process flow diagram for generating a test code for a composite service in accordance with an exemplary embodiment of the present invention.

FIG. 7 presents a process flow diagram for validating a service-oriented architecture path associated with a client application in accordance with an exemplary embodiment of the present invention.

FIG. 8 depicts a section of an exemplary service-oriented architecture with monitoring nodes in accordance with an exemplary embodiment of the present invention.

FIG. 9 presents a process flow diagram for monitoring and reporting the performance of a service-oriented architecture for a client application in accordance with an exemplary embodiment of the present invention.

FIG. 10 presents a process flow diagram for reporting the cost and efficiencies of a service-oriented architecture for a client application in accordance with an exemplary embodiment of the present invention.

### DETAILED DESCRIPTION OF THE EXEMPLARY EMBODIMENTS

Exemplary embodiments of the present invention provide systems and methods for an enhanced service-oriented computer architecture that develops and uses enhanced service contracts, that is, service contracts that include both static and dynamic parameters, to design, deploy, and operate an enterprise computer network. The enhanced service contract can support the design, deployment, testing, and operation of an enterprise-wide service-oriented architecture. The enhanced service contract may include both static and dynamic parameters and may be contained in an electronic format, which would facilitate automating some of the design, deployment, testing, and operation functions. The enhanced service contract can support validating system requirements for a service, including developing of test code used to test services. The enhanced service contract can also support performance testing during operations and a means for allocating system costs and optimizing system resources.

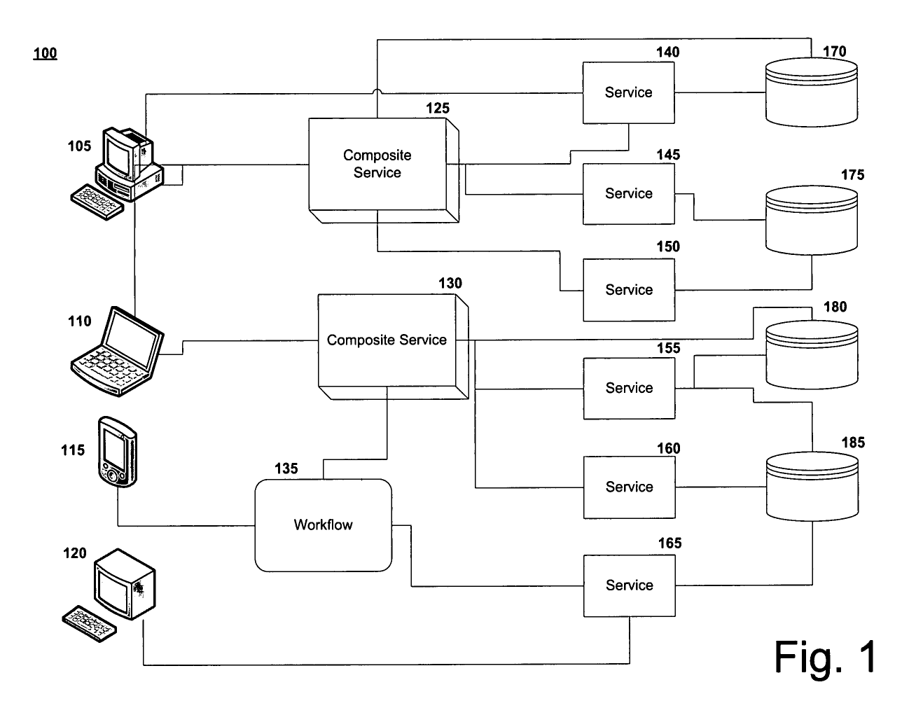

FIG. 1 depicts an operating environment 100 in accordance with an exemplary embodiment of the present invention. Referring to FIG. 1, the exemplary operating environment, or enterprise computer network, 100 includes multiple client devices, such as personal computer 105, laptop computer 110, personal data assistant (PDA) 115 and terminal 120. These client devices can access a variety of services on the enterprise computer network 100, including composite services 125, 130, and constituent services 140, 145, 150, 155, 160, 165.

For example, personal computer 105 represents a client device that accesses software-based services supplied by the enterprise computer network 100. The personal computer 105 may access constituent services, such as service 140, or composite services, such as composite service 125. A composite service is a service that relies on two or more constituent services to operate. As an illustration, composite service 125 relies on constituent services 140, 145, and 150. For example, the composite service 125 may require a level of security for its data and, accordingly, will rely on service 140 to provide for data encryption. The network includes a registry (not shown) that contains service interface information for each composite service. That is, the registry serves as a roadmap for identifying which constituent services comprise a composite service. One of ordinary skill in the art will recognize that constituent services 140, 145, 150, 155, 160, and 165 may be individual services or may themselves be composite services that rely on other individual services.

A constituent service may access a database as part of its operation, such as service 140 accessing database 170. More than one service may access a single database, such as service 145 and service 150 accessing database 175. Similarly, a single service may access multiple databases, such as service 155 accessing database 180 and database 185. Also, composite services may directly access a database, such as composite service 125 accessing database 170 and composite service 130 accessing database 180.

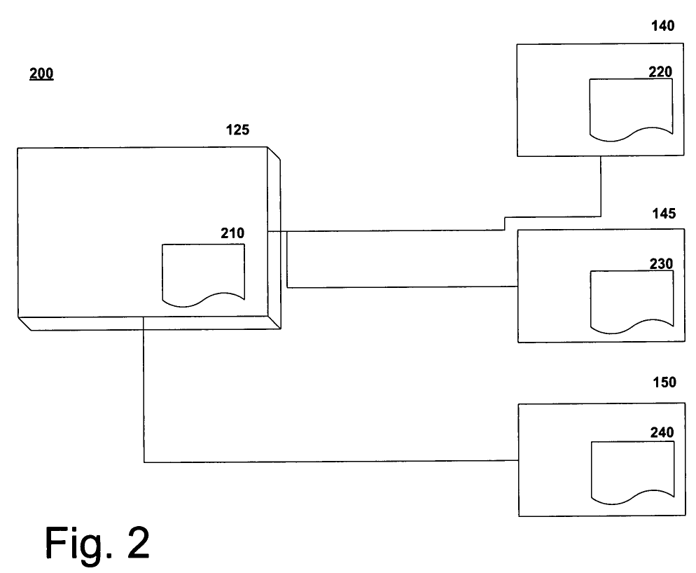

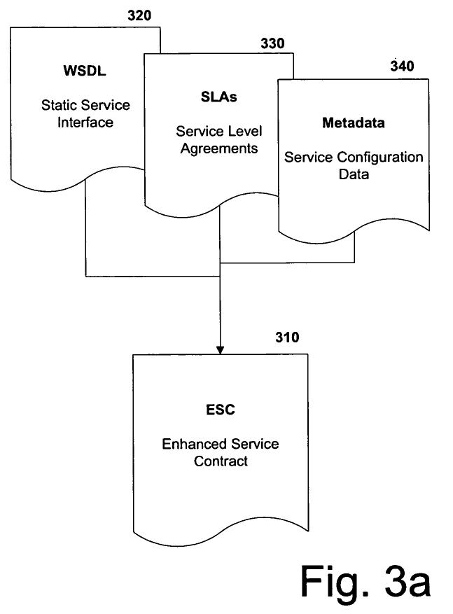

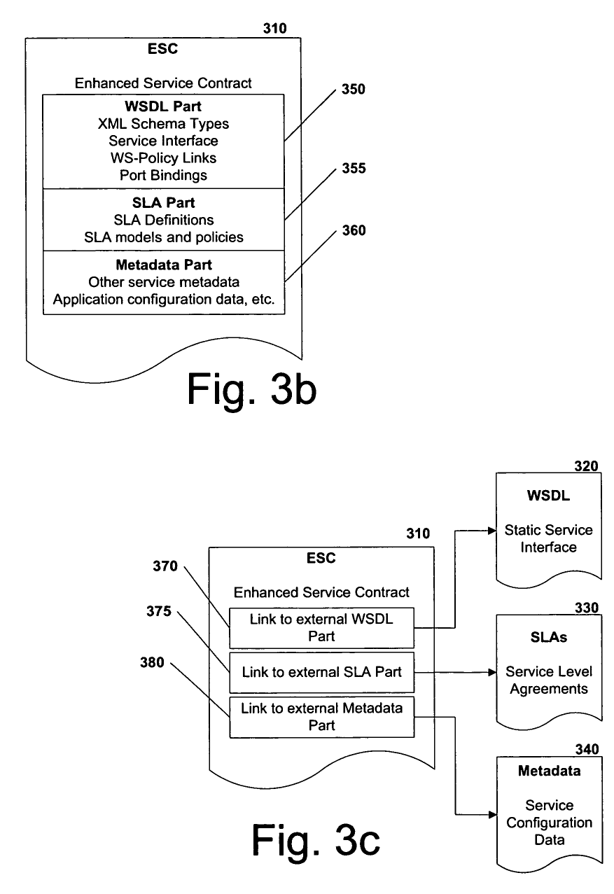

A client device may access a workflow, such as PDA 115 accessing workflow 135. A workflow defines a specific set of tasks necessary to produce an outcome. For example, in an accounting business, a workflow may route a spreadsheet containing calculations to a supervisor for that supervisor's review and approval, then route the spreadsheet to another process that uses the results of those calculations as input for further additional calculations. In the exemplary computer network 100, the workflow 135 relies on composite service 130 and constituent service 165 in performing its set of tasks. In this exemplary embodiment of the present invention, each composite service and constituent service would have an enhanced service contract associated with it (not shown). The enhanced service contract is discussed in greater detail below, in conjunction with FIGS. 2 and 3.

FIG. 2 depicts a segment 200 of the operating environment 100 and illustrates enhanced service contracts in accordance with an exemplary embodiment of the present invention. Referring to FIGS. 1 and 2, composite service 125 relies on constituent services 140, 145, and 150. Each service has an associated enhanced service contract, such as enhanced service contract 210, 220, 230, 240. A registry (not shown) would include both service interface information and identify the enhanced service contract associated with each service.

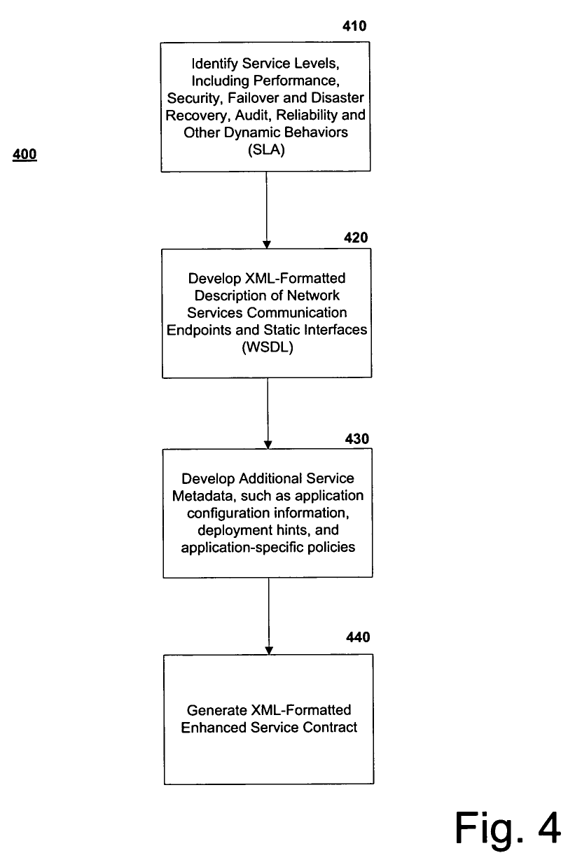

An exemplary enhanced services contract, such as enhanced service contract 210, 220, 230, 240, specifies both static and dynamic aspects of a service. The enhanced service contract 210, 220, 230, 240 supports many aspects of an enterprise computer network based on SOA. Some of these aspects include system design, testing, governance, monitoring, cost chargeback, and reporting. The composition and development of enhanced service contracts are discussed in greater detail below, in connection with FIGS. 3 and 4.

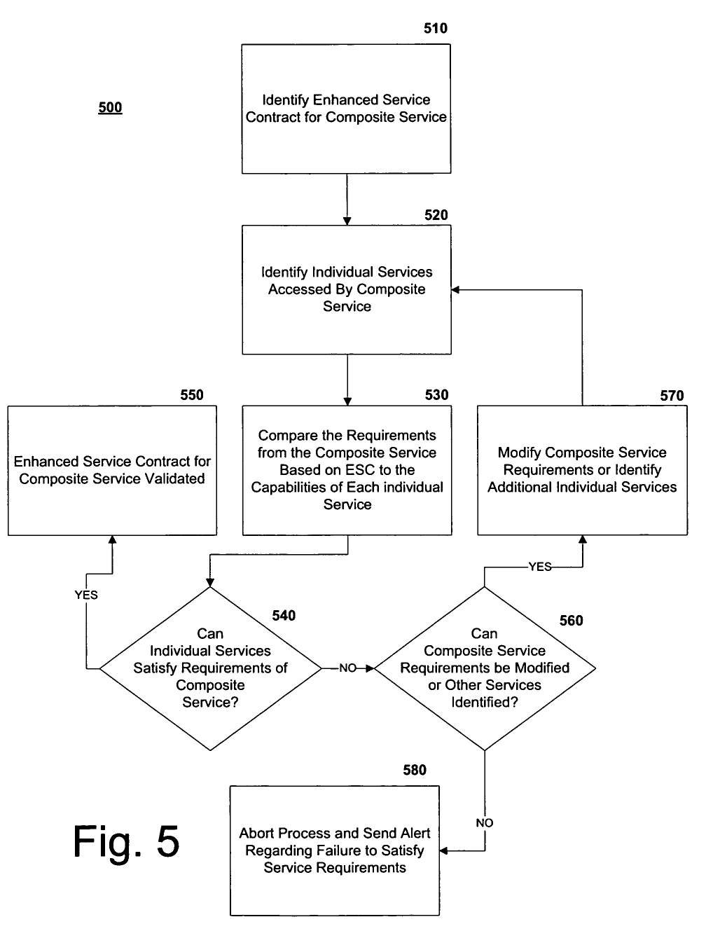

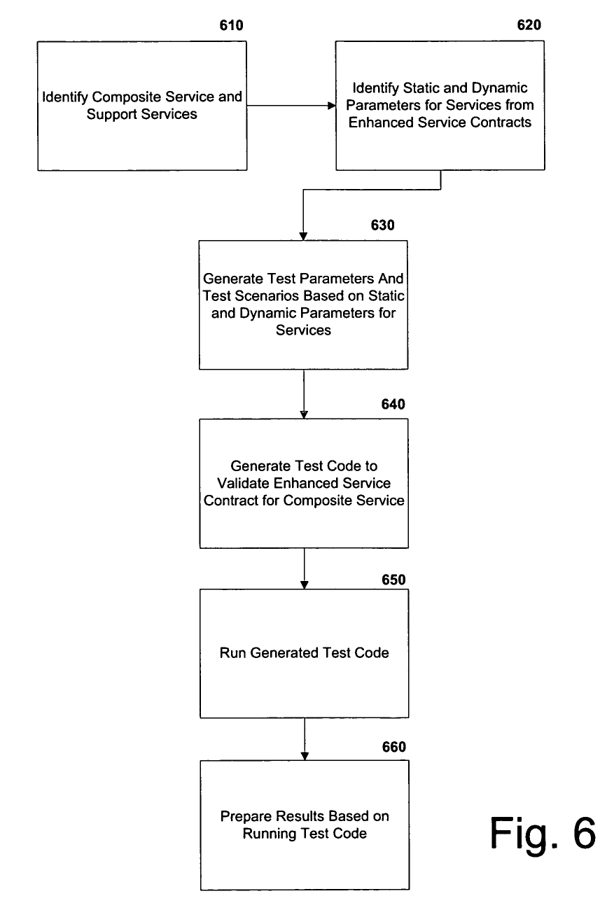

The enhanced services contract 210 for a composite service 125 may be developed independent of the constituent services 140, 145, 150 upon which the composite service 125 relies. However, the enhanced service contract 210 must be consistent with the enhanced service contracts 220, 230, 240 of the constituent services. This aspect of enhanced service contracts are discussed in greater detail below, in connection with FIG. 5.

FIG. 3a depicts the composition of an enhanced services contract 310 for an exemplary embodiment of the present invention. Referring to FIG. 3a, the enhanced services contract 310 includes static service interface parameters 320, service level agreement requirements 330 and service configuration data 340. Web Services Description Language (WSDL) is one example of static service interface parameters 320. WSDL is an XML-based language for defining World Wide Web services and describes the protocols and formats used by the service. Examples of static service interface parameters 320 include, but are not limited to, service name, operating environment, and valid data type. The service level agreement requirements 330, typical of a non-service-oriented architecture for an enterprise computer network, represent dynamic requirements for a service. Examples of service level agreement requirements 330 include, but are not limited to, performance-based requirements, such as latency (the time it takes for an operation to complete), throughput, and concurrency; security requirements, such as authentication and access control and encryption; failover and disaster recovery; logging/auditing; and transactional messaging. An additional dynamic parameter may be cost, such as the cost per invocation that the customer is willing to pay for the service, provided that the other parameters are satisfied. Service Configuration Data 340, as the name suggests, provides configuration information for the service. As one example, this data may include the identity of an information source, such as a specific database, that the service needs to operate. The Service Configuration Data 340 may be stored as metadata.

FIG. 3b depicts the composition of an enhanced services contract 312 for an exemplary embodiment of the present invention. Referring to FIGS. 3a and 3b, the enhanced service contract 312, which is an exemplary embodiment of the enhanced service contract 310, includes a WSDL component 350, a Service Level Agreement (SLA) component 355, and a Metadata component 360. In this exemplary embodiment, the enhanced service contract 312 have these three components expressly included in a single document, such as an extensible Mark-up Language (XML) document. That is, the static interface parameters, such as would be provided in a WSDL component 350, the dynamic requirements—such as would be contained in an SLA component 355, and configuration data—such as would be contained in a Metadata component 360, are written to a single XML document to form the enhanced service contract 312. In this way, the enhanced service contract 310, in XML form, can be associated with the specific service. One of ordinary skill in the art would recognize that the enhanced service contract 312 could be written in a different electronic form from XML. Similarly, one of ordinary skill in the art would recognize that WSDL, SLA, and configuration requirements comprise a typical listing of requirements and that the enhanced service contract 312 could include other static and dynamic parameters.

FIG. 3c depicts the composition of an enhanced services contract 310 for an alternative exemplary embodiment of the present invention. Referring to FIGS. 3a, 3b, and 3c, the enhanced service contract 318, which is an exemplary embodiment of the enhanced service contract 310, also includes a WSDL component 370, a SLA component 375, and a Metadata component 380. However, unlike the enhanced service contract 312, which expressly contains the static interface parameters 350, the dynamic requirements 355, and the configuration data 360, the enhanced service contract 318 contains links to reference documents containing this information. In this exemplary embodiment, the WSDL component 370 is a link to an external WSDL document 372, the SLA component 375 is a link to an SLA document 377, and the Metadata component 380 is a link to a Metadata document 382. Again, one of ordinary skill in the art would recognize that WSDL, SLA, and configuration requirements comprise a typical listing of requirements and that the enhanced service contract 318 could have other static and dynamic requirements.

FIG. 4 presents an overall process flow diagram 400 for developing an enhanced service contract for a service in accordance with an exemplary embodiment of the present invention. Referring to FIGS. 2, 3b, 3c, and 4, at step 410, a user identifies service levels for a service, such as service 140. These service levels may include service performance requirements, security requirements, failover and disaster recovery requirements, audit requirements, reliability requirements, and other dynamic behaviors for the service. These identified service levels would include requirement types that are similar to requirements identified for a service level agreement. In this exemplary embodiment, this description would be formatted as an XML document.

At step 420, a user develops a description of network services communication endpoints and static interface parameters. In this exemplary embodiment, this description would be formatted as an XML document. These static parameters would be similar to those described in a WSDL document. At step 430, a user would develop service configuration information as additional service metadata. These data may include application configuration information, deployment hints, and application-specific policies. Again, in the exemplary embodiment, this description would be formatted as an XML document.

At step 440, a user would generate an enhanced services contract in an electronic format, such as enhanced service contract 220 for service 140. This enhanced service contract may be a single XML document, such as enhanced service contract 312 or a document containing links to the documents developed at steps 410, 420, and 430, such as enhanced service contract 318. One of ordinary skill in the art would appreciate that an alternative configuration for the enhanced services contract generated at step 440 may include both express requirements and links to electronic document containing additional requirements. Similarly, one of ordinary skill in the art would appreciate that different users may perform the different steps of the process 400.

FIG. 5 presents a process flow diagram 500 for validating an enhanced services contract for a composite service in accordance with an exemplary embodiment of the present invention. Referring to FIGS. 1, 2 and 5, at step 510, a validator identifies an enhanced service contract for a composite service, such as enhanced service contract 210 for composite service 125. At step 520, the validator identifies constituent services that are accessed by the composite service, by referencing the registry containing service information. For example, composite service 125 accesses constituent services 140, 145, and 150.

At step 530, the validator compares the requirements for the composite service as contained in the enhanced service contract to the capabilities of each constituent service accessed by the composite service, as identified in step 520. These requirements may be taken from each constituent service's enhanced service contract. For example, in validating the enhanced service contract 210 for composite service 125, the enhanced service contracts 220, 230, and 240, corresponding to constituent services 140, 145, and 150, respectively, would serve as the basis for the comparison at step 530.

At step 540, the validator determines, based on the comparison at step 540, whether the constituent services satisfy the requirements of the composite service. If the determination is “YES,” the process 500 moves to step 550 and terminates, with the enhanced service contract for the composite service being validated. If the determination is “NO,” the process 500 moves to a determination at step 560.

At step 560, the validator determines if the composite service requirements, as specified in the enhanced services contract, can be modified or if other constituent services that may support the composite service can be identified. If the determination is “YES,” the process 500 moves to step 570. At this step, the composite service's enhanced service contract is modified or additional or replacement constituent services are identified. For example, the enhanced service contract 210 for composite service 125 may be modified to reduce a security parameter. Alternatively, a constituent service, such as service 155, may be accessed by the composite service, either in addition to services 140, 145, 150, or as a replacement for one of those constituent services, in order to bring the composite service 125 into compliance with its enhanced services contract. The validator identifies replacement services using information contained in the registry for services. The process 500 then returns to step 520. If the determination is “NO,” the process 500 moves to step 580. At step 580, the process 500 is aborted and an alert is sent that the requirements of the composite service have not been satisfied.

The process 500 may be employed during the design phase of a composite service, at the deployment phase of that composite service, or whenever changes are made to the system that touch the composite service, such as a change to a constituent service accessed by the composite service. One of ordinary skill in the art would appreciate that the validator for process 500 could be a person or that the process 500 could be automated, such that the validator is a computer-based program that automatically compares the requirements for the composite service to the capabilities of the constituent services accessed thereby. Alternatively, the process could be performed through a combination of human and automated steps.

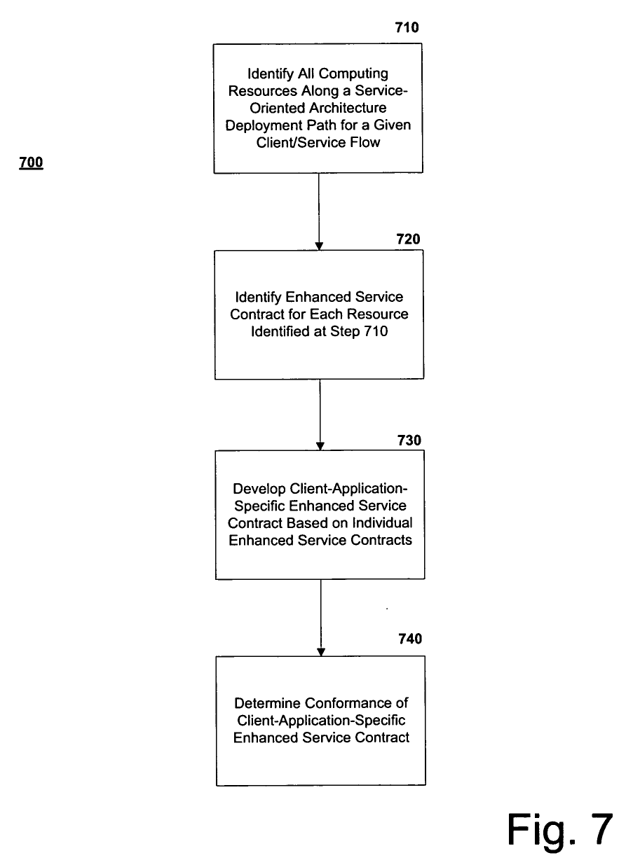

FIG. 6 presents a process flow diagram 600 for generating a test code for testing a composite service in accordance with an exemplary embodiment of the present invention. Referring to FIGS. 2 and 6, at step 610, a composite service and its accessed constituent services are identified. For example, composite service 125 identifies and accesses constituent services 140, 145, and 150. At step 620, static and dynamic parameters are identified for the composite service and each constituent service identified at step 610. These static and dynamic parameters are taken from the enhanced service contracts for each of the composite and constituent services, such as enhanced service contract 210, enhanced service contract 220, enhanced service contract 230, and enhanced service contract 240, which correspond to composite service 125, constituent service 140, constituent service 145, and constituent service 150, respectively.

Examples of typical dynamic parameters include performance requirements; security requirements; failover and disaster recovery requirements; audit requirements; reliability requirements; and other dynamic behaviors for the service. An additional dynamic parameter may include cost, such as the amount of money the customer is willing to pay per invocation to have the service operate at the given performance level. Static parameters delineate the communications protocols and interfaces for a service, for example.

At step 630, test parameters and test scenarios are generated based on the identified static and dynamic parameters. The test scenarios incorporate the parameters identified at step 620 and may consider other external factors. These factors may include the type of tests to be run (such as ramp-up tests, soak tests, and peak-rest tests) and the type of data to be used (such as random data, biased data, or historical data). For example, a test scenario may employ a soak test, which is a long-term test that tests the robustness of a service, using historical data to simulate actual expected conditions.

At step 640, test code is generated to validate the service contracts of the composite service and each associated service. This step differs from the process 500 described in FIG. 5. In that process, the composite service's enhanced service contract is validated, based on the enhanced service contract of each of the constituent services accessed by the composite service, which provides a measure of the capabilities of that composite service. Process 600 will include actually running the service modules through test scenarios to confirm that the services meet the capabilities specified in each of the enhanced service contract.

According to an exemplary embodiment, one set of code would be developed to test the dynamic parameters and one set developed to test the static parameters. These sets of test code would be generated automatically the static and dynamic parameters identified from the enhanced service contract at step 620. The test code may rely on preexisting test modules that were previously developed to test constituent services, such as service 140. As such, the appropriate test modules could be combined with the generated test code to form the complete test module. Examples of how these pre-existing modules may be combined with the test code include “wrapper” and “framework” configurations. In the wrapper configuration, the modules are incorporated into the generated test code, which “wraps around” these pre-existing modules. In the framework configuration, the generated test code would access the pre-existing test modules, such as by passing data to and from the module.

The generated test code will include all of the dynamic and static parameters identified at step 620, although, according to the exemplary embodiment, the dynamic parameters will be used to develop one set of test code and the static parameters will be used to generate a second set of test code. As such, a single test scenario will test all dynamic parameters concurrently, rather than testing the individual parameters one-by-one. This approach is advantageous over the current approach for testing components of a service-oriented architecture, which does not test a composite service in light of the constituent services that are accessed by it.

At step 650, the test code is run. Again, the number or invocations and the type of data used in the test code run will be dictated by the test scenarios developed at step 630 and will depend on what goals are meant to be achieved by the testing. At step 660, a test report is generated. The report compares the results of the test to the enhanced service contract requirements and identifies any requirements that were violated. The report also may identify actual performance values that could be used to optimize the enhanced service contract. For example, testing may show that the measured latency was 2 milliseconds even though the enhanced service contract specified a latency of 5 milliseconds. This reported result could be used to revise the enhanced service contract to include the more critical measured parameter, in this case, changing the latency from 5 milliseconds to 2 milliseconds.

FIG. 7 presents a process flow diagram 700 for validating a service-oriented architecture path associated with a client application in accordance with an exemplary embodiment of the present invention. Referring to FIG. 7, at step 710, all network resources along a service-oriented architecture path for a client application are identified. A client application may be comprised of multiple composite and constituent services, along with those services' associated databases. At step 710, all components attributable to a single client application are identified.

At step 720, the enhanced service contract for each resource is identified. A registry would contain the location of the enhanced services contract file for each resource. At step 730, the separate enhanced service contracts are used to develop an enhanced service contract specific to the client application. This step identifies the limiting value for each parameter in a path and assigns that value to the client application enhanced service contract. At step 740, the values identified at step 730 are reviewed to determine if the enhanced service contract for the client application is acceptable, or if it conforms to the requirements of the client application. The determination at step 740 may include comparing the values determined at step 730 with an enhanced service contract for the client application. In this way, the process 700 is comparable to the process 500, which is discussed above in connection with FIG. 5. The difference is that process 700 relates to validating an entire client application path, while process 500 relates to validating a composite service. What results from process 700 is either an enhanced service contract for a client application that is validated or an enhanced service contract that is developed based on the resource capabilities of the services and components that comprise the client application.

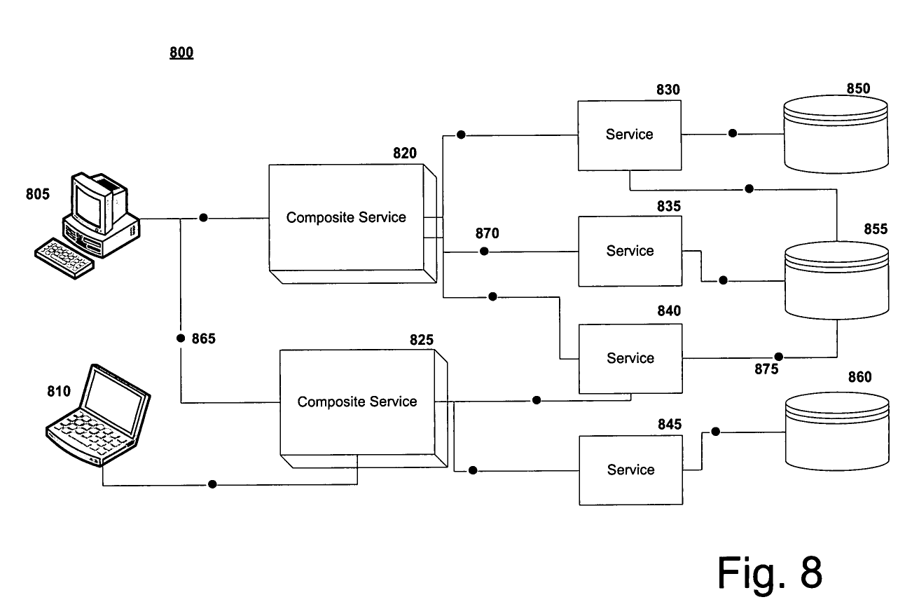

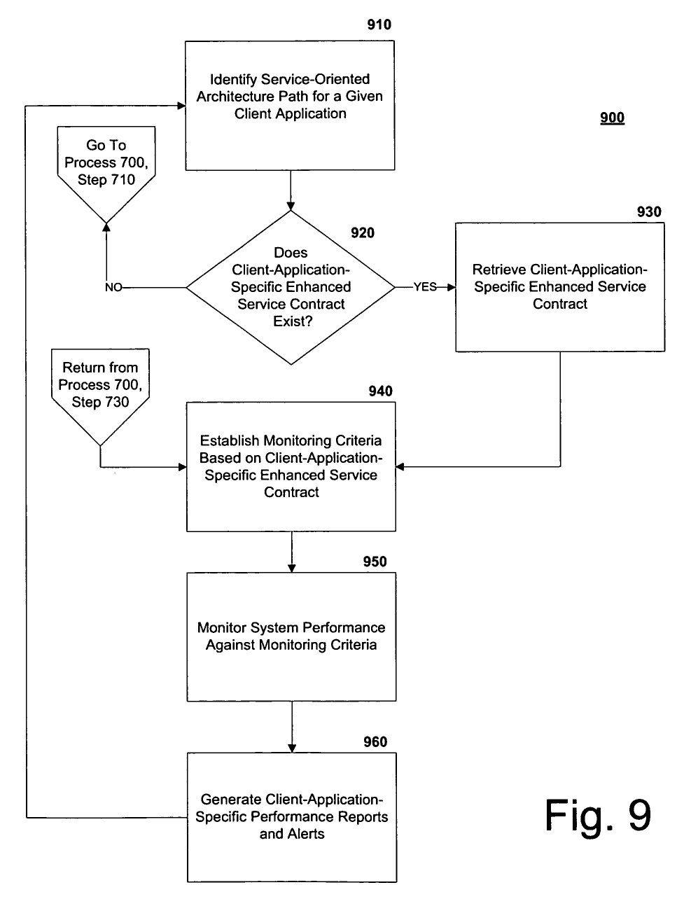

FIG. 8 depicts a section of an exemplary service-oriented architecture 800 with monitoring nodes in accordance with an exemplary embodiment of the present invention. Referring to FIG. 8, personal computer 805 and laptop computer 810 represent two client devices that can access the exemplary service-oriented architecture 800. This exemplary service-oriented architecture 800 includes composite services 820, and 825, constituent services 830, 835, 840, 845, and databases 850, 855, 860. The exemplary service-oriented architecture 800 also includes multiple monitoring nodes, such as nodes 865, 870, and 875. These nodes can be used to monitor the performance of the overall system. The acceptability of that performance can be measured against the parameters provided for an enhanced service contract associated with a specific monitoring node. By employing enhanced service contracts, monitoring the system at different points can provide meaningful performance data. A process for employing this monitoring is discussed below, in connection with FIG. 9.

FIG. 9 presents a process flow diagram 900 for monitoring and reporting the performance of a service-oriented architecture for a client application in accordance with an exemplary embodiment of the present invention. Referring to FIG. 9, at step 910, all network resources along a service-oriented architecture path for a client application are identified. A client application may be comprised of multiple composite and constituent services, along with those services' associated databases. At step 910, all components attributable to a single client application are identified.

At step 920, the process 900 determines if an enhanced service contract specific to the client application exists. If the result of this determination is “NO,” the process moves to process 700 to generate an enhanced service contract specific to the client application. Otherwise, at step 930, the enhanced service contract for the identified client application is retrieved.

The process 900 then moves to step 940, either from step 930 or from process 700. At step 940, monitoring criteria are established from the enhanced service contract. For example, a throughput value is taken from the enhanced service contract and is used as a monitoring criterion. At step 950, the system monitors the operation of the services against the performance criteria.

At step 960, the process 900 generates a performance report for the client application. Additionally, alerts may be generated when specific criteria are exceeded. Although FIG. 9 is directed to a client application, one of ordinary skill in the art would appreciate that the monitoring could be directed to specific composite or constituent services.

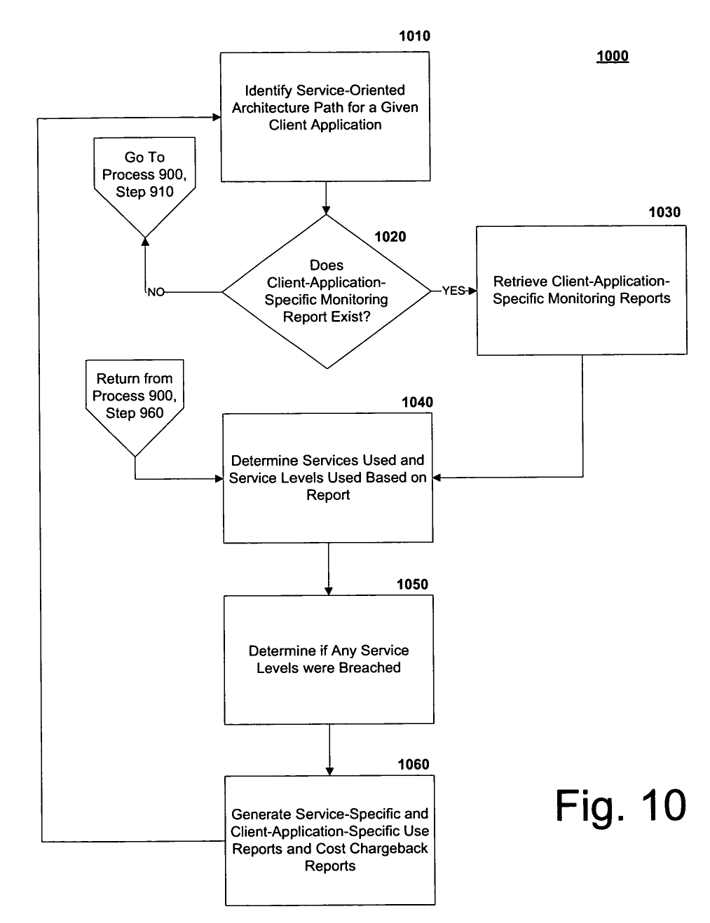

FIG. 10 presents a process flow diagram 1000 for reporting the cost and efficiencies of a service-oriented architecture for a client application in accordance with an exemplary embodiment of the present invention. Referring to FIG. 10, at step 1010, all network resources along a service-oriented architecture path for a client application are identified. A client application may be comprised of multiple composite and constituent services, along with those services' associated databases. At step 1010, all components attributable to a single client application are identified.

At step 1020, the process 1000 determines if a client-application-specific monitoring report exists. If the result of this determination is “NO,” the process moves to process 900 to generate a client-application-specific monitoring report. Otherwise, at step 1030, the monitoring report for the identified client application is retrieved.

The process 1000 then moves to step 1040, either from step 1030 or from process 900. At step 1040, the monitoring report is used to determine which services were used and at what levels were they used. At step 1050, the process 1000 identifies which service levels, as specified in the associated enhanced service contract, were breached.

At step 1060, the process 1000 generates cost and optimization reports. Cost reports allocate the cost of using specific services to each client application. This cost may be based on a rate specified in the enhanced service contract or may be based on prorated use of a service. Also, the cost may be discounted if service levels specified in the enhanced service agreement are breached. An optimization report can identify overused and underused services and identify significant difference between required service levels and achieved service levels. For example, an enhanced service contract may specify a capacity of 10,000 concurrent users, but the optimization report may identify that the peak use for a service was 2,000 concurrent users. This identified difference could lead to modifying the enhanced service contract for that application to require a smaller capacity, which may result in a cost savings. Although FIG. 10 is directed to a client application, one of ordinary skill in the art would appreciate that the monitoring could be directed to specific composite or constituent services.

In view of the foregoing, one would appreciate that the present invention supports a system and method for using an enhanced service contract to support the design, deployment, testing, and operation of an enterprise-wide service-oriented architecture. The enhanced service contract may include both static and dynamic parameters and may be contained in an electronic format, which would facilitate automating some of the design, deployment, testing, and operation functions. The enhanced service contract can support validating system requirements for a service, including developing of test code used to test services. The enhanced service contract can also support performance testing during operations and a means for allocating system costs and optimizing system resources.

What is claimed is:

1. A system for providing a service-oriented architecture, comprising:
an enterprise information technology system comprising a plurality of services; and
an enhanced services contract associated with each of the services, the enhanced services contract comprising a first requirement comprising a static parameter of one of the services and a second requirement comprising a dynamic parameter of the service.

2. The system of claim 1 wherein the static parameter comprises a static interface parameter.

3. The system of claim 1 wherein the dynamic parameter comprises a service level requirement.

4. The system of claim 1 wherein the enterprise information technology system comprises multiple platform technologies.

5. The system of claim 1 wherein the enhanced services contract further comprises metadata associated with the service.

6. The system of claim 1 wherein the enhanced services contract comprises an XML document.

7. The system of claim 1 further comprising a test module operable to generate test code based on the first requirement and the second requirement.

8. The system of claim 1 further comprising a monitoring module operable to monitor the performance of the enterprise information technology system based on the enhanced services contract for each of the services.

9. A method for generating an enhanced services contract comprising the steps of:
identifying a service level requirement for a service of a service-oriented enterprise information technology system;
identifying a static interface parameter for the service; and
generating a computer readable document comprising the service level requirement and the static interface parameter.

10. The method of claim 9 further comprising the step of developing metadata for the service wherein the computer-readable document further comprises metadata developed for the service.

11. The method of claim 9 wherein the computer-readable document comprises an XML document.

12. A method for evaluating a composite service for a service oriented enterprise information technology system comprising the steps of:
identifying for the composite service an enhanced services contract comprising a first set of requirements;
identifying for each constituent service accessed by the composite service an enhanced services contract comprising a second set of requirements; and
evaluating whether the second set of requirements satisfy the first set of requirements to determine whether the constituent services can satisfy the first set of requirements.

13. The method of claim 12 further comprising the step of modifying the first set of requirements if the second set of requirements does not satisfy the first set of requirements, wherein the modified first set of requirements enables the second set of requirements to satisfy the first set of requirements.

14. The method of claim 12 further comprising the step of identifying one or more additional services to be accessed by the composite service if the second set of requirements does not satisfy the first set of requirements, wherein the additional services enable the second set of requirements to satisfy the first set of requirements.

15. The method of claim 12 further comprising the step of alerting a user if the second set of requirements does not satisfy the first set of requirements.

16. A method for testing a composite service of a service oriented enterprise information technology system comprising the steps of:
identifying the composite service and one or more constituent services accessed by the composite service, wherein the composite service and the one or more constituent services each comprise an enhanced services contract;
identifying a set of requirements from the enhanced services contracts for the composite service and the constituent services; and
generating a test code based on the set of requirements, wherein the test code tests one or more capabilities of the composite service and the constituent services.

17. A method for evaluating a client/service flow of a service oriented enterprise information technology system comprising the steps of:
identifying all service oriented enterprise information technology system resources comprising the client/service flow;
associating an enhanced services contract with each identified resource;
automatically developing an enhanced services contract specific to a client/service flow based on each enhanced services contract associated with each identified resource, wherein enhanced services contract specific to a client/service flow comprises a set of requirements; and
evaluating the set of requirements to determine the acceptability of the requirements for the client/service flow.

18. A method for evaluating the performance of a client/service flow of a service oriented enterprise information technology system comprising the steps of:
retrieving an enhanced services contract associated with the client/service flow of a service oriented enterprise information technology system;
establishing monitoring criteria based on the enhanced services contract; and
comparing the performance of the system to the established monitoring requirements.

19. The method of claim 18 further comprising the step of generating a report comprising the results of comparing the performance of the system to the established monitoring requirements.

20. A method for evaluating the performance of a client/service flow of a service oriented enterprise information technology system comprising the steps of:
retrieving an enhanced services contract comprising one or more service levels associated with the client/service flow of a service oriented enterprise information technology system;
retrieving a monitoring report for the client/service flow of a service oriented enterprise information technology system services;
determining the services used by the client/service flow of a service oriented enterprise information technology system; and
determining if any service levels for the client/service flow of a service oriented enterprise information technology system were breached.

21. The method of claim 20 further comprising the step of generating a report comprising the results of determine if any service levels for the client/service flow of a service oriented enterprise information technology system were breached.

22. A computer-readable storage device storing a set of computer-executable instructions implementing a method for generating an enhanced services contract comprising the steps of:
identifying a service level requirement for a service of a service-oriented enterprise information technology system;
identifying a static interface parameter for the service; and
generating a computer readable document comprising the service level requirement and the static interface parameter.

23. The method of claim 22 further comprising the step of developing metadata for the service wherein the computer-readable document further comprises metadata developed for the service.

24. The method of claim 22 wherein the computer-readable document comprises an XML document.

25. A computer-readable storage device storing a set of computer-executable instructions implementing a method for evaluating a composite service for a service oriented enterprise information technology system comprising the steps of:
identifying for the composite service an enhanced services contract comprising a first set of requirements;
identifying for each constituent service accessed by the composite service an enhanced services contract comprising a second set of requirements; and
evaluating whether the second set of requirements satisfy the first set of requirements to determine whether the constituent services can satisfy the first set of requirements.

26. The computer-readable storage device of claim 25 further comprising the step of modifying the first set of requirements if the second set of requirements does not satisfy the first set of requirements, wherein the modified first set of requirements enables the second set of requirements to satisfy the first set of requirements.

27. The computer-readable storage device of claim 25 further comprising the step of identifying one or more additional services to be accessed by the composite service if the second set of requirements does not satisfy the first set of requirements, wherein the additional services enable the second set of requirements to satisfy the first set of requirements.

28. The computer-readable storage device of claim 25 further comprising the step of alerting a user if the second set of requirements does not satisfy the first set of requirements.

29. A computer-readable storage device storing a set of computer-executable instructions implementing a method for testing a composite service of a service oriented enterprise information technology system comprising the steps of:
identifying the composite service and one or more constituent services accessed by the composite service, wherein the composite service and the one or more constituent services each comprise an enhanced services contract;
identifying a set of requirements from the enhanced services contracts for the composite service and the constituent services; and
generating a test code based on the set of requirements, wherein the test code tests one or more capabilities of the composite service and the constituent services.

30. A computer-readable storage device storing a set of computer-executable instructions implementing a method for evaluating a client/service flow of a service oriented enterprise information technology system comprising the steps of:
identifying all service oriented enterprise information technology system resources comprising the client/service flow;
associating an enhanced services contract with each identified resource;
automatically developing an enhanced services contract specific to a client/service flow based on each enhanced services contract associated with each identified resource, wherein enhanced services contract specific to a client/service flow comprises a set of requirements; and
evaluating the set of requirements to determine the acceptability of the requirements for the client/service flow.

31. A computer-readable storage device storing a set of computer-executable instructions implementing a method for evaluating the performance of a client/service flow of a service oriented enterprise information technology system comprising the steps of:
retrieving an enhanced services contract associated with the client/service flow of a service oriented enterprise information technology system;
establishing monitoring criteria based on the enhanced services contract; and
comparing the performance of the system to the established monitoring requirements.

32. The computer-readable storage device of claim 31 further comprising the step of generating a report comprising the results of comparing the performance of the system to the established monitoring requirements.

33. A computer-readable storage device storing a set of computer-executable instructions implementing a method for evaluating the performance of a client/service flow of a service oriented enterprise information technology system comprising the steps of:
retrieving an enhanced services contract comprising one or more service levels associated with the client/service flow of a service oriented enterprise information technology system;
retrieving a monitoring report for the client/service flow of a service oriented enterprise information technology system services;
determining the services used by the client/service flow of a service oriented enterprise information technology system; and
determining if any service levels for the client/service flow of a service oriented enterprise information technology system were breached.

34. The computer-readable storage device of claim 33 further comprising the step of generating a report comprising the results of determine if any service levels for the client/service flow of a service oriented enterprise information technology system were breached.
